(19) United States
(12) Patent Application Publication
(10) Pub. No.: US 2025/0390262 A1
(43) Pub. Date: Dec. 25, 2025

(54) NON-TRANSITORY COMPUTER READABLE STORAGE MEDIUM, SERVER, AND LABEL DATA SHARING SYSTEM

(71) Applicant: BROTHER KOGYO KABUSHIKI KAISHA, Nagoya (JP)

(72) Inventors: Ryoji Ban, Kiyosu (JP); Fuyuko Ito, Nagoya (JP); Ryoko Okamoto, Nagoya (JP)

(21) Appl. No.: 19/313,800

(22) Filed: Aug. 28, 2025

Related U.S. Application Data
(63) Continuation of application No. PCT/JP2024/010734, filed on Mar. 19, 2024.

(30) Foreign Application Priority Data
Mar. 31, 2023 (JP) 2023-058405

(51) Int. Cl. G06F 3/12

(52) U.S. Cl. CPC G06F 3/1258; G06F 3/1205

(57) ABSTRACT

A non-transitory computer readable storage medium storing a program. The program is configured to be executed by a server configured to connect to an information processing device. The server includes a first list that is a list of print media configured to be set. The program includes instructions that, when executed by the server, cause a computer of the server to execute upload acceptance processing of accepting an upload of label data from the information processing device, and acquisition processing of acquiring first medium information associated with the label data accepted in the upload acceptance processing. The information processing device is configured to acquire, from a label printer connected to the information processing device, the first medium information indicating a print medium mounted on the label printer, and to store the acquired first medium information in association with the label data.

### REFERENCE TO RELATED APPLICATIONS

This is a continuation application of International Application No. PCT/JP2024/010734 filed on Mar. 19, 2024, which claims priority from Japanese Patent Application No. 2023-058405 filed on Mar. 31, 2023. The entire contents of the aforementioned applications are incorporated herein by reference.

### BACKGROUND ART

In a related art, as a system for sharing content data, a system is known in which a server for saving content data is prepared on the Internet and the content data is downloaded to a device of a user.

In a points management system disclosed in the related art, photograph data is uploaded from a PC of a user A to a WWW server, and the photograph data is purchased by a PC of a user B and downloaded from the WWW server.

In recent years, a system for sharing label data used for printing a label in a label printer has been studied. When posting the label data to the server, it is necessary to set various types of information in the label data, but the setting work is troublesome to the poster. The related art discloses a system for sharing photograph data via a WWW server, but does not disclose a mechanism for reducing the trouble at the time of posting.

### SUMMARY

A non-transitory computer readable storage medium storing a program, the program being configured to be executed by a server configured to connect to an information processing device, the server including a first list that is a list of print media configured to be set,
in which the program including instructions that, when executed by the server, cause a computer of the server to execute:
   upload acceptance processing of accepting an upload of label data from the information processing device; and
   acquisition processing of acquiring first medium information associated with the label data accepted in the upload acceptance processing,
the information processing device is configured to acquire, from a label printer connected to the information processing device, the first medium information indicating a print medium mounted on the label printer, and to store the acquired first medium information in association with the label data,
the instructions further cause the computer of the server to execute:
   first extraction processing of extracting, from the first list, a print medium matching the first medium information acquired in the acquisition processing;
   selection processing of accepting selection of a print medium from a second list, the second list being a list of print media in which the print medium extracted in the first extraction processing is displayed on a priority basis; and
   registration processing of registering the label data accepted in the upload acceptance processing in association with second medium information indicating the print medium selected in the selection processing.

### BRIEF DESCRIPTION OF DRAWINGS

FIG. 1 is a diagram schematically illustrating a label data sharing system.

FIG. 2 is a diagram schematically illustrating a configuration of a terminal.

FIG. 3 is a sequence diagram illustrating an example of a body medium information storage procedure.

FIG. 4 is a diagram illustrating an example of screen transition.

FIG. 5 is a diagram illustrating an example of a label file.

FIG. 6 is a sequence diagram illustrating an example of a printing procedure.

FIG. 7 is a sequence diagram illustrating an example of a posting procedure.

FIG. 8 is a diagram illustrating an example of a print medium list.

FIG. 9A is a diagram illustrating a display example of an extracted list.

FIG. 9B is a diagram illustrating a display example of an extracted list.

FIG. 10 is a sequence diagram illustrating an example of a download procedure.

FIG. 11 is a diagram schematically illustrating a label data sharing system.

FIG. 12 is a sequence diagram illustrating an example of a posting procedure.

FIG. 13 is a diagram illustrating an example of a post screen.

### DESCRIPTION

Hereinafter, embodiments embodying a label data sharing system will be described in detail with reference to the accompanying drawings. The present embodiment discloses a label data sharing system in which a server and a plurality of information processing devices are connected via a network to share label data used for printing a label in a label printer.

### First Embodiment

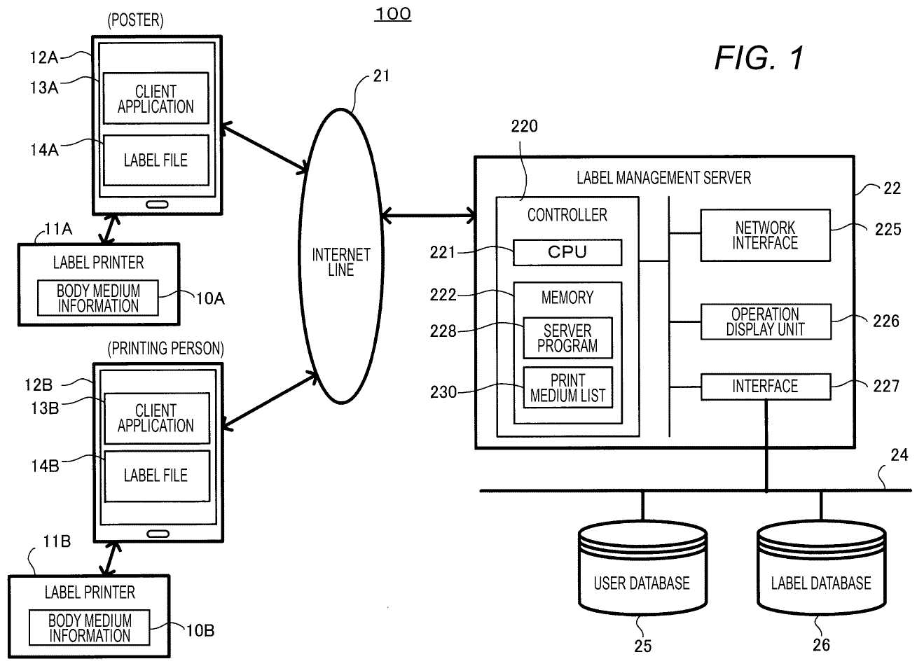

As illustrated in FIG. 1, a label data sharing system 100 (hereinafter abbreviated as “system 100”) according to a first embodiment is, for example, a system provided to a user by a vendor, that is, the maker of the label printer. The system 100 includes a terminal 12A, a terminal 12B, and a label management server 22, which are connected via an Internet line 21. The terminals 12A and 12B are terminals owned by the owner or the user of the label printer. The terminals 12A and 12B are configured to be connected to label printers 11A and 11, respectively. The label printers 11A and 11B is configured to store body medium information 10A and 10B, respectively, which are medium information related to the mounted tape. The tape is an example of a “print medium”.

The terminals 12A and 12B are information processing devices having a communication function, a display function, and an operation function. The terminals 12A and 12B according to the present embodiment are implemented with smartphones, and may be implemented with tablets or personal computers. The terminals 12A and 12B is configured to store client application programs (hereinafter referred to as “client applications”) 13A and 13B, respectively. The number of terminals connected to the label management server 22 is not limited to the present embodiment. In addition, the terminals 12A and 12B may be collectively referred to as a “terminal 12” if it is not particularly necessary to distinguish them. The client applications 13A and 13B may be collectively referred to as a “client application 13” if it is not particularly necessary to distinguish them. In addition, the label printers 11A and 11B may be collectively referred to as a “label printer 11” if it is not particularly necessary to distinguish them. In addition, the body medium information 10A and 10B may be collectively referred to as “body medium information 10” if it is not particularly necessary to distinguish them.

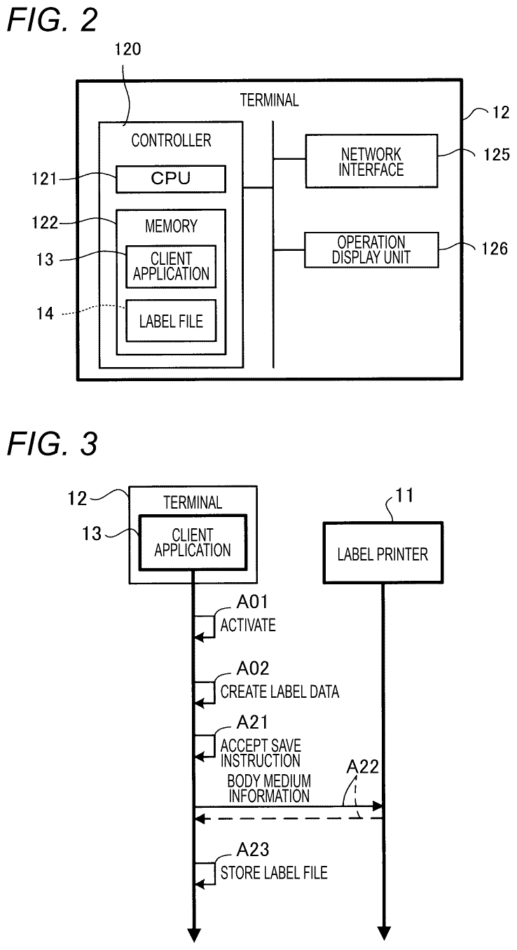

As illustrated in FIG. 2, the terminal 12 includes a controller 120 including a CPU 121 and a memory 122. The terminal 12 includes a network interface (hereinafter referred to as a “network IF”) 125 and an operation display unit 126, which are connected to the controller 120.

The label management server 22 as illustrated in FIG. 1 is a device having at least a storage function and a communication function. The label management server 22 includes a controller 220 including a CPU 221 and a memory 222. The label management server 22 includes a network interface (hereinafter referred to as a “network IF”) 225, an operation display unit 226, and an interface 227, which are connected to the controller 220. The label management server 22 according to the present embodiment has a web server function, and can provide a web page to an external device such as the terminal 12.

The terminal 12A of a user who posts the label data (hereinafter referred to as a “poster”) is an example of an “information processing device”. The CPU 121 of the terminal 12A is an example of a “computer of the information processing device”. The controller 120 of the terminal 12A may be an example of the “computer of the information processing device”. The operation display unit 126 of the terminal 12A is an example of a “user interface”. The client application 13A is an example of a “program executable by an information processing device”. The label management server 22 is an example of a “server”. The Internet line 21 is an example of a “network”. The CPU 221 is an example of a “computer of a server”. The controller 220 may be an example of a “computer of a server”.

The CPUs 121, 221 are configured to execute various types of processing, in accordance with programs read from the memories 122, 222 and based on a user's operation. The memories 122, 222 are storage areas storing various programs and various data.

For example, the memory 122 is configured to store the client application 13. The memory 122 is configured to store a label file 14 for each piece of label data. The label file 14 is a file including information on a label. The label file 14 may be a label file including label data created by a user using the client application 13, or may be a label file downloaded from the label management server 22. The label file 14 will be described later.

For example, the memory 222 is configured to store a server program 228. Moreover, the memory 222 is configured to store a print medium list 230. The print medium list 230 is an example of a “first list”. The memories 222, 122 are used as work areas when executing various types of processing. The print medium list 230 will be described later.

Examples of the memories 122, 222 are not limited to a ROM, a RAM, an HDD, and the like incorporated into the device, and may be a storage medium readable and writable by the CPUs 121, 221. The storage medium readable by the CPUs 121, 221 includes a recording medium such as a CD-ROM and a DVD-ROM in addition to the above examples.

The operation display units 126, 226 include hardware configured to display a screen for notifying a user of information, and hardware configured to accept an operation from the user. The operation display units 126, 226 may be a touch panel having both a display function and an operation accepting function, or may be a set of a display having a display function and a keyboard, a mouse, a trackball, or the like having an operation accepting function.

The network IFs 125, 225 include hardware for communicating with an external device. Communication standards of the network IFs 125, 225 include Ethernet (registered trademark), Wi-Fi (registered trademark), and the like. The communication mode of the network IFs 125, 225 may be wired or wireless. The networks IF 125, 225 of the present embodiment are connected to the Internet line 21.

The client application 13 stored in the terminal 12 is an application program provided by the vendor of the label printer 11. The client application 13 has a function of creating and editing label data on the terminal 12. The client application 13 has a function of storing a label file 14 including created or edited label data in the memory 122. The client application 13 has a function of posting, that is, uploading, the label file 14 stored in the memory 122 to the label management server 22. The client application 13 has a function of downloading label data from the label management server 22. The client application 13 has a function of printing the label data created on the terminal 12 and the downloaded label data using the label printer 11.

The label printer 11 is, for example, a printing device that includes a thermal transfer printhead and performs printing while unwinding a tape wound in a roll shape. For example, the label printer 11 prints an image on the accommodated tape and conveys the tape based on a print job received from the terminal 12, and causes the printed portion to protrude to the outside of the machine. A label having a predetermined label length and a predetermined label width is created with the tape protruding to the outside of the machine. The “label width” is a dimension in a direction orthogonal to a direction in which the label is conveyed out from the label printer 11, that is, a width direction. The “label length” is the length in the direction in which the label is conveyed out from the label printer 11, that is, the size in the length direction.

The label printer 11 is connected to the terminal 12 by wireless LAN communication such as Wi-Fi (registered trademark) or short-range wireless communication such as Bluetooth (registered trademark). The label printer 11 and the terminal 12 may be connected by wire using the USB communication standard.

There are a plurality of types of tapes usable in the label printer 11. For example, the type of the tape may be distinguished depending on the width of the tape, the color of the tape or the ink, or the material of the tape or the presence or absence of special processing. Models of label printers compatible with the tape are determined in advance depending on the type of the tape. The user can replace the label printer with a tape of a type suitable for the purpose or application among a plurality of types of tapes compatible with the model of the label printer to perform printing.

The medium information, which is information regarding the tape, includes, for example, a plurality of items such as the tape width, the tape color, the ink color and the tape type of the tape. The medium information may include a tape model number. The tape type is, for example, a cloth tape or a laminated tape subjected to lamination. In a tape cassette that accommodates the tape, holes having different formation positions and shapes are formed for each item of the medium information. The label printer 11 can detect a parameter set for each item of the medium information based on the hole formed in the tape cassette mounted on the body. Hereinafter, the medium information detected by the label printer 11 is referred to as “body medium information”. The body medium information may be stored in the label printer 11 or may be stored in an external device. The body medium information may be stored in an IC chip provided in the tape cassette, and the label printer 11 may include a reading device for reading the IC chip.

The client application 13 can create a label file 14 including label data to be edited, posted, or printed, and save the label file 14 in the memory 122. The client application 13 has a function of acquiring the body medium information 10 from the label printer 11 and storing the acquired body medium information 10 in the label file 14. Further, the client application 13 has a function of passing the label file 14 to the label management server 22. These functions will be described later.

A user database (hereinafter referred to as “user DB”) 25 and a label database (hereinafter referred to as “label DB”) 26 are connected to the interface 227 of the label management server 22 via a wired LAN 24. The user DB 25 and the label DB 26 may be included in the label management server 22 or may be included in a server different from the label management server 22. Alternatively, the user DB 25 and the label DB 26 may be included in different servers. The user DB 25 and the label DB 26 will be described later.

The server program 228 stored in the label management server 22 is a program for controlling the operation of the label management server 22. The server program 228 can provide a web page for accepting label data to be posted (hereinafter referred to as “posted label data”). On this web page, the user can set a tape suitable for the posted label data. This is to make it easy for a user other than the poster to grasp a tape suitable for the posted label data from among various tapes.

The server program 228 has a function of registering the posted label data in the label DB 26. The server program 228 has a function of transmitting the label data registered in the label DB 26 to the terminal 12. Functions of the server program 228 will be described later. The server program 228 is an example of a “program for being executed by a server”.

Next, the operation of the system 100 will be described. In the system 100, the posted label data is shared by posting the label data to the label management server 22 or transmitting the posted label data from the label management server 22 to the terminal 12. Hereinafter, a user registration procedure will be described, and then a body medium information storage procedure, a first label posting procedure, next and subsequent label posting procedures, and download and printing procedures will be described.

Processing steps in the present embodiment basically indicate processing of the CPUs 221, 121 according to instructions mainly described in programs such as the server program 228 and the client application 13. The processing by the CPUs 221, 121 also include hardware control using APIs of the OS. In the present specification, a detail description of the OS is omitted, and an operation of each program is described.

### (User Registration Procedure)

A user who uses the system 100 performs user registration in the label management server 22, for example, when installing the client application 13 in the terminal 12. For example, when the terminal 12 requests the label management server 22 to perform user registration, the label management server 22 provides and displays a user registration screen on the terminal 12. The user registration screen includes, for example, a user name input field and a password setting field. Upon accepting an input of a user name or the like via the user registration screen, the label management server 22 registers the accepted information in the user DB 25.

The user registration may be performed if the client application 13 is not installed, for example, when the user first posts the label data or when the user first downloads the label data.

### (Body Medium Information Storage Procedure)

An example of the body medium information storage procedure will be described with reference to the sequence diagram of FIG. 3. The client application 13 is configured to acquire the body medium information 10 from the label printer 11 and to store the body medium information 10 in association with the label data, in a case where the label data is edited and in a case where the label data is printed. First, a procedure for storing the body medium information 10 during label data editing will be described.

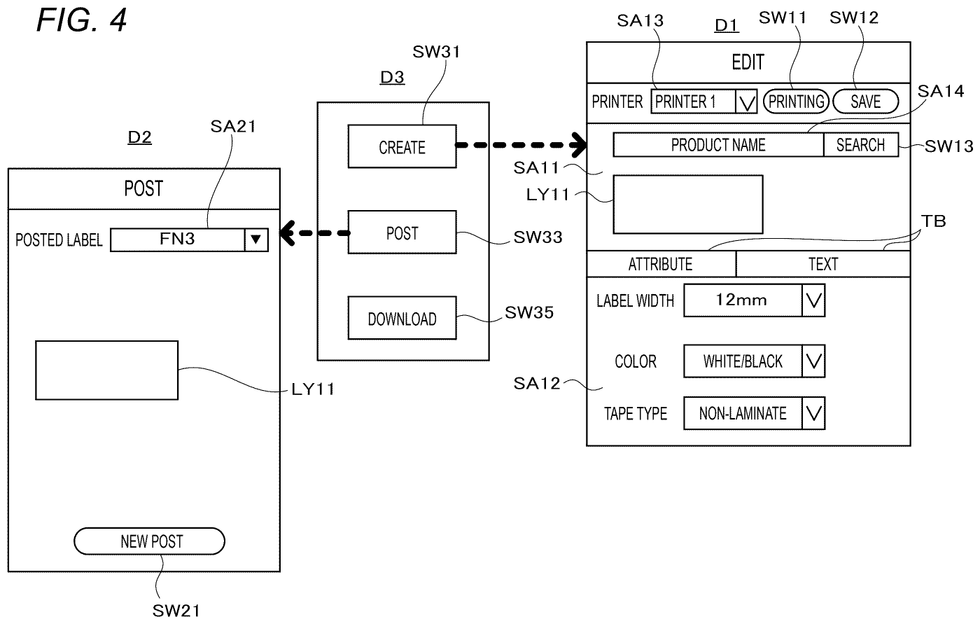

The user activates the client application 13 installed in the terminal 12 (A01) and creates label data (A02). Specifically, for example, as illustrated in FIG. 4, when the client application 13 is activated, the terminal 12 displays a menu screen D3. The menu screen D3 includes a creation button SW31 for instructing creation of label data, a posting button SW33 for instructing posting of label data, and a download button SW35 for instructing downloading of label data.

When the creation button SW31 is operated, the terminal 12 displays the edit screen D1. The edit screen D1 includes a printer selection field SA13, an editing area SA11, a setting area SA12, a print button SW11, and a save button SW12. The printer selection field SA13 can display a list of printers registered in the client application 13 or the terminal 12, and accept selection of a printer to execute printing. In the present embodiment, the label printer 11 is selected in the printer selection field SA13.

The editing area SA11 is an area for accepting editing of a label. In the editing area SA11, label image data LY11 of a label to be edited is displayed. The setting area SA12 can accept various types of setting information according to the capability of the selected label printer 11. The various types of setting information include medium information related to the tape used for printing the label data and object information related to an object used for the label. The medium information includes, for example, the tape width, the tape color, the ink color, and the tape type of the tape used for printing the label. Hereinafter, the medium information set in the setting area SA12 is referred to as “set medium information”.

The edit screen D1 allows the user to edit the label image data even if the terminal 12 is offline. Therefore, the set medium information set on the edit screen D1 may not match the body medium information 10 of the selected label printer 11.

Examples of the object used for the label include a text object, a symbol mark object, an image object, a graphic object, a frame object, and a two-dimensional code object. Since there are many items that can be accepted on the edit screen D1, the client application 13 can accept an instruction to switch the item to be set by a plurality of tabs TB.

Returning to FIG. 3, when the user edits the label image data LY11 and operates the save button SW12, the client application 13 accepts a save instruction (A21). The client application 13 acquires the body medium information 10 from the label printer 11 selected in the printer selection field SA13 of the edit screen D1 (A22). The processing of A22 is an example of “body acquisition processing”.

The client application 13 saves the label file 14 including the label data edited on the edit screen D1 and the body medium information 10 acquired in A22 in the memory 122 (A23). The processing of A23 is an example of “saving processing”.

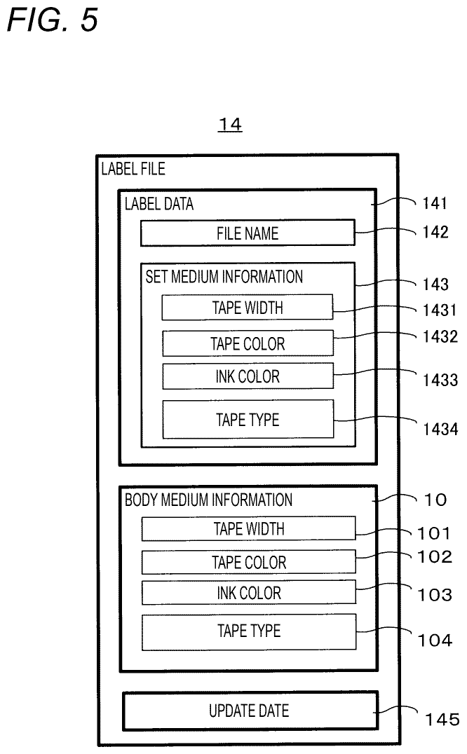

As illustrated in FIG. 5, the label file 14 includes label data 141, body medium information 10, and an update date 145. The label data 141 includes a file name 142 and set medium information 143. The set medium information 143 includes items including a tape width 1431, a tape color 1432, an ink color 1433, and a tape type 1434. The tape width, the tape color, the ink color, and the tape type set on the edit screen D1 are stored in each item.

The body medium information 10 includes items including a tape width 101, a tape color 102, an ink color 103, and a tape type 104. The tape width, the tape color, the ink color, and the tape type included in the body medium information 10 acquired in A22 are stored in each item. The update date 145 stores the date of creation or update of the label file 14.

When saving the label file 14, in a case where the body medium information is already stored, the client application 13 overwrites the existing body medium information with the acquired body medium information 10. In a case where the client application 13 is offline or the like and thus fails to acquire the body medium information 10, the client application 13 saves the label file 14 without including the body medium information in the label file 14.

After storing the label file 14 corresponding to the label data created on the edit screen D1 in the memory 122, the client application 13 closes the edit screen D1 and causes the terminal 12A to redisplay the menu screen D3.

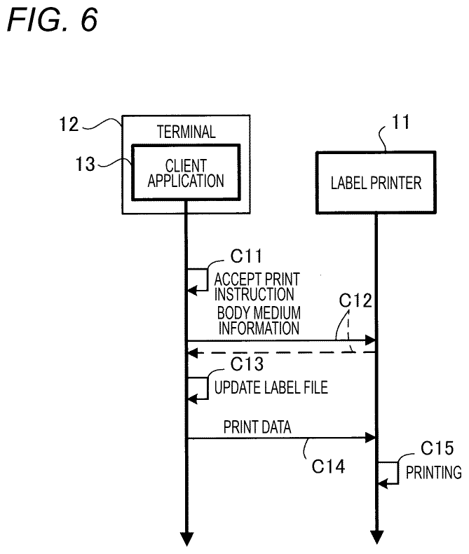

Next, a procedure of the client application 13 saving the body medium information 10 when printing the label data will be described with reference to FIG. 6. In the edit screen D1, an operation on the print button SW11 can be accepted in a state where one of the plurality of label files stored in the memory 122 is selected. In this case, as illustrated in FIG. 6, the client application 13 accepts a print instruction (C11). Upon accepting the print instruction, the client application 13 acquires the body medium information 10 from the selected label printer 11 (C12). The client application 13 overwrites and updates the body medium information 10 of the selected label file 14 with the acquired body medium information 10 (C13). The client application 13 updates the update date 145 of the label file 14. The client application 13 transmits print data to the label printer 11 (C14). The label printer 11 executes printing based on the print data (C15).

By acquiring the body medium information 10 from the client application 13 not only at the time of editing but also at the time of printing, the client application 13 can acquire the body medium information 10 from the label printer 11 and store the body medium information 10 in association with the label data at the time of printing, even if being offline at the time of editing and thus failing to acquire the body medium information 10. In addition, since the medium information actually used for printing is stored, it can be expected to store medium information more appropriate than at the time of editing.

### (Posting Procedure)

The label management server 22 according to the present embodiment has a function of allowing the poster to set the tape at the time of posting the label data and registering the posted label data and the tape set by the poster in the label DB 26 in association with each other. When a user other than the poster downloads the posted label data, the label management server 22 transmits the posted label data added with the tape information set by the poster to the terminal of the other user. This increases the possibility that another user checks and uses the tape set by the poster when using the posted label data. This is because it can be expected that the posted label data is printed with the quality assumed by the poster.

For example, there are 300 to 400 types of tape, depending on the size, color and tape type. It is troublesome for the poster to find and set a desired tape from among such a large number of tapes. On the other hand, the poster is likely to print the posted label data with a label printer 11 available to the poster. That is, the tape corresponding to the body medium information of the label printer used by the poster is highly likely to be a tape matching the posted label data.

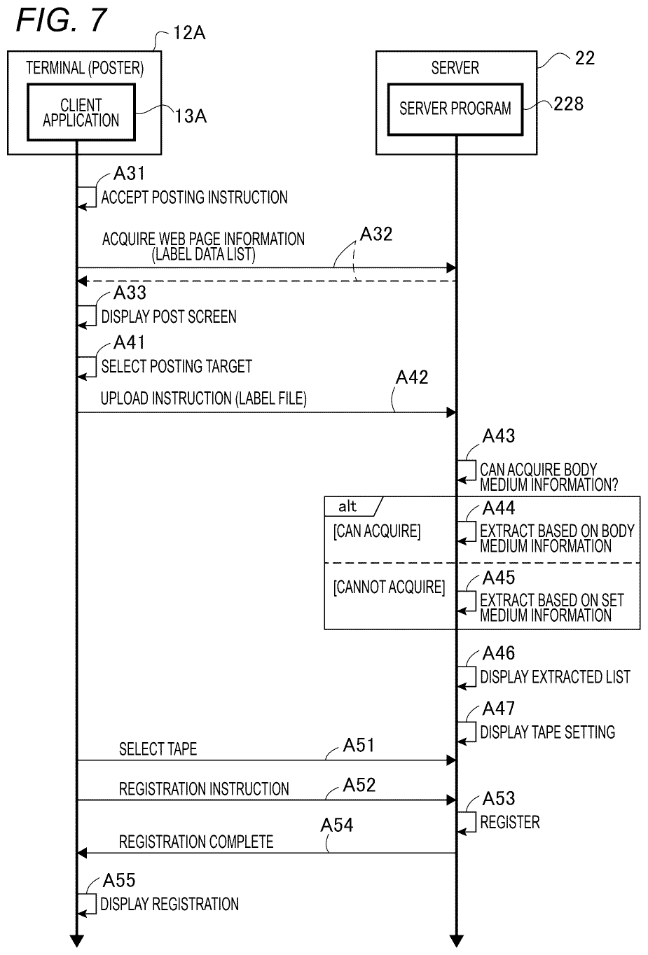

Therefore, the label management server 22 according to the present embodiment includes the print medium list 230, which is a list of settable tapes, and is configured such that the client application 13 extracts a tape from the print medium list based on the body medium information 10 acquired from the label printer 11, and the poster selects a tape from an extracted list in which the extracted tape is displayed on a priority basis. Hereinafter, the posting procedure will be described with reference to FIG. 7. Here, a case where the poster posts a label file 14A from the terminal 12A to the label management server 22 will be described as an example. Hereinafter, the label file 14 posted by the poster is referred to as the label file 14A.

When the posting button SW33 on the menu screen D3 is operated, the client application 13A accepts a posting instruction (A31). The posting button SW33 is associated with a URL of a post screen provided by the label management server 22. In a case where the client application 13A has a browser function, the client application 13A accesses the label management server 22 using the browser function of the client application 13A and causes the terminal 12A to display a post screen (A32, A33). In a case where the client application 13A does not have a browser function, the client application 13A passes the URL to another program such as a browser installed in the terminal 12A. The other program accesses the label management server 22 using the URL received from the client application 13A, and causes the terminal 12A to display the post screen.

For example, the post screen D2 illustrated in FIG. 4 includes a posting target selection section SA21 and a new post button SW21. The file name of the label file as the posting target is displayed in the posting target selection section SA21 in a selectable manner. The posting target is the label file 14A saved in the memory 122. The post screen D2 can display the label image data LY11 corresponding to the label file selected in the posting target selection section SA21. Thus, the poster can confirm the content of the label data to be posted. The new post button SW21 is an operator for accepting an upload instruction to post the label data.

When the poster selects the label file 14A as the posting target in the posting target selection section SA21 (A41) and operates the new post button SW21, the label management server 22 accepts an upload instruction (A42). The label file 14A selected as the posting target is added to the upload instruction. The processing of A42 is an example of “acquisition processing”. The label management server 22 determines whether the body medium information can be acquired from the label file 14A added to the upload instruction (A43).

For example, as illustrated in FIG. 5, in a case where the label file 14A added to the upload instruction includes the body medium information 10, the label management server 22 determines that the body medium information can be acquired (alt: can acquire). In this case, the label management server 22 extracts, from the print medium list 230, the tape fitting the body medium information 10 included in the label file 14A (A44). The processing of A44 is an example of “extraction processing”.

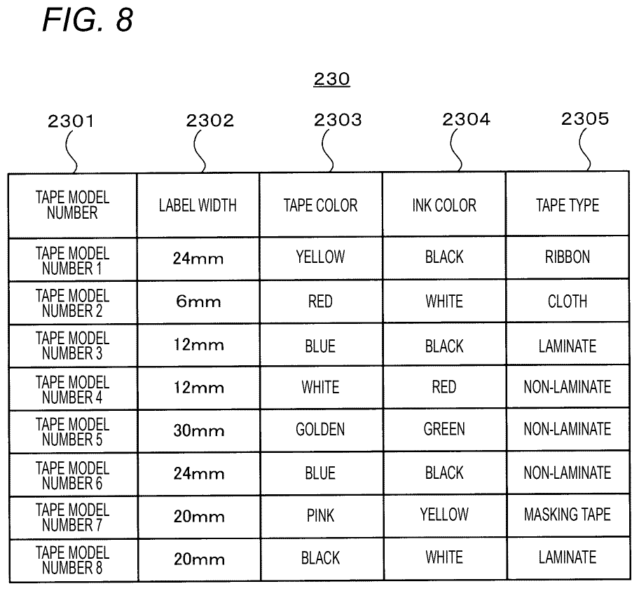

Specifically, for example, as illustrated in FIG. 8, for each tape model, the print medium list 230 stores a tape model number 2301, a tape width 2302, a tape color 2303, an ink color 2304, and a tape type 2305 in association with each other. For example, assume that the body medium information 10 stores “12 mm”, “blue”, “black”, and “laminate” in the items including the tape width 101, the tape color 102, the ink color 103, and the tape type 104, respectively. As illustrated in FIG. 8, all the items of the body medium information 10 match the tape including the tape model number “tape model number 3”. Therefore, the label management server 22 extracts the tape of “tape model number 3” from the print medium list 230.

For example, as illustrated in FIG. 8, the label width “12 mm” of the body medium information 10 matches the tape including the tape model number “tape model number 4”. Therefore, the label management server 22 extracts the tape of “tape model number 4” from the print medium list 230.

For example, as illustrated in FIG. 8, the tape color “blue” and the ink color “black” of the body medium information 10 match the tape including the tape model number “tape model number 6”. Therefore, the label management server 22 extracts the tape of “tape model number 6” from the print medium list 230.

For example, as illustrated in FIG. 8, the tape type “laminate” of the body medium information 10 matches the tape including the tape model number “tape model number 8”. Therefore, the label management server 22 extracts the tape of “tape model number 8” from the print medium list 230.

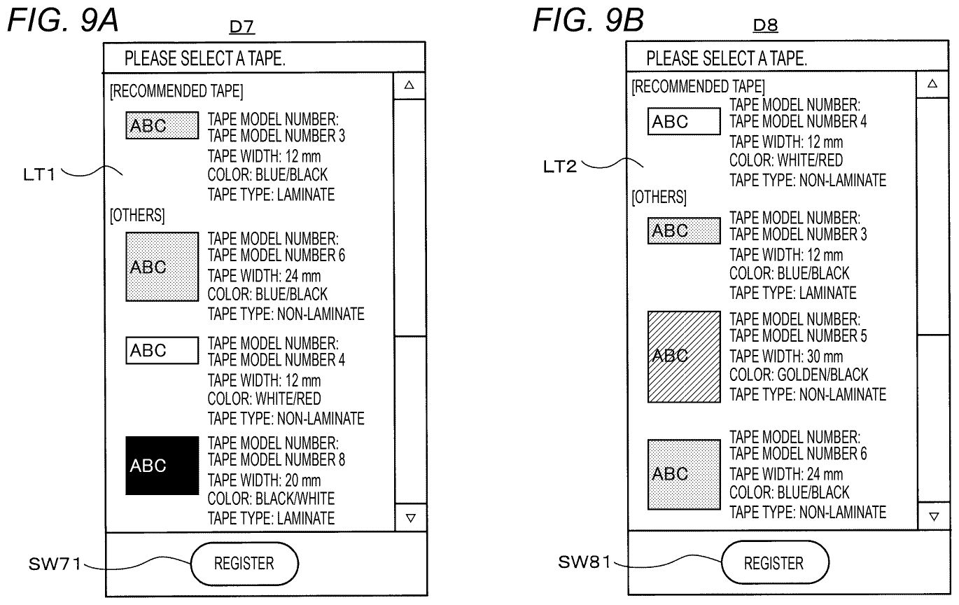

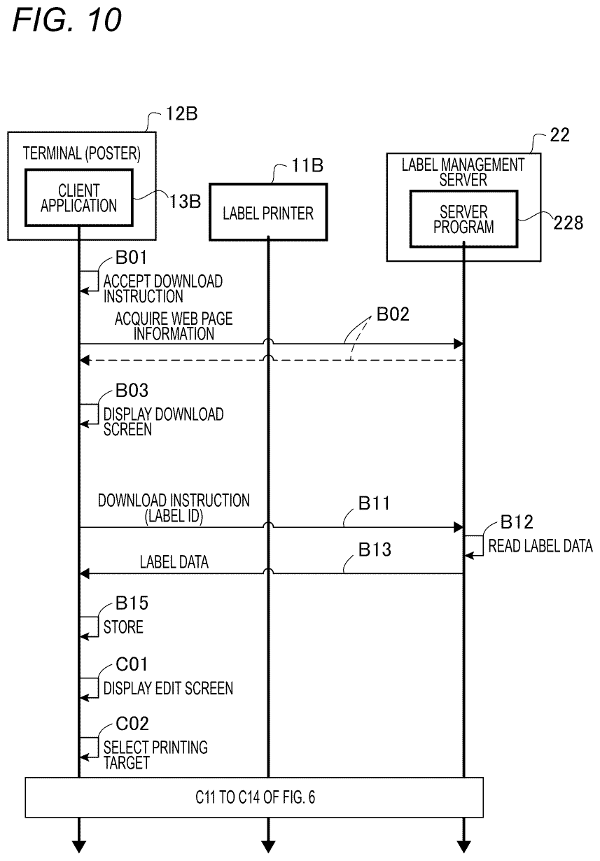

The label management server 22 creates an extracted list in which the tape extracted in A44 (A46) is displayed on a priority basis, and displays a tape setting screen including the extracted list (A47). Specifically, the label management server 22 creates an extracted list LT1 in which “tape model number 3”, “tape model number 4”, “tape model number 6”, and “tape model number 8” extracted in A44 is displayed on a priority basis, and causes the terminal 12A to display a tape setting screen D7 including the created extracted list LT1 as illustrated in FIG. 9A. The extracted list LT1 is an example of a “second list”.

In the present embodiment, a tape having no item matching the body medium information 10 is excluded from the extracted list LT1. Therefore, the number of tapes included in the extracted list LT1 is smaller than that in the print medium list 230 illustrated in FIG. 8. Therefore, the tape setting screen D7 in FIG. 9A has a smaller number of tape options than a case where all the tapes of the print medium list 230 are displayed, which allows the poster to easily select the tape.

Moreover, in the extracted list LT1, the tape of “tape model number 3”, which matches all the items of the body medium information 10, is arranged above the tapes of “tape model number 4”, “tape model number 6”, and “tape model number 8”, which match some items of the body medium information 10, and is displayed at the head of the tape setting screen D7. This increases the possibility that the poster selects a tape matching the posted label data.

Further, in a case where there are a plurality of tapes matching some items of the body medium information 10, the tapes are arranged in the extracted list LT1 in descending order of the number of matching items. Therefore, on the tape setting screen D7, a tape having a larger number of items matching the body medium information 10 is displayed closer to the head. This reduces the trouble for the poster to select a tape matching the label data to post even in a case where a tape matching some the items of the body medium information 10 is included in the extracted list LT1 and the selection of the tape is wide.

On the other hand, in a case where the label file 14A added to the upload instruction does not include the body medium information 10, the label management server 22 determines that the body medium information cannot be acquired (alt: cannot acquire). In this case, the label management server 22 acquires the set medium information 143 from the label file 14A and extracts a tape fitting the set medium information 143 from the print medium list 230 stored in the memory 222 (A45). The set medium information 143 is an example of “information set in the label data”. The processing of A45 is an example of “second extraction processing”.

For example, assume that the set medium information 143 stores “12 mm”, “white”, “red”, and “non-laminate” in the items including the tape width 1431, the tape color 1432, the ink color 1433, and the tape type 1434, respectively. As illustrated in FIG. 8, all the items of the set medium information 143 match the tape including the tape model number “tape model number 4”. Therefore, the label management server 22 extracts the tape of “tape model number 4” from the print medium list 230.

Further, for example, as illustrated in FIG. 8, the label width “12 mm” of the set medium information 143 matches the tape including the tape model number “tape model number 3”. Therefore, the label management server 22 extracts the tape of “tape model number 3” from the print medium list 230.

For example, as illustrated in FIG. 8, the tape type “non-laminate” of the set medium information 143 matches the tape including the tape model numbers “tape model number 5” and “tape model number 6”. Therefore, the label management server 22 extracts the tapes of “tape model number 5” and “tape model number 6” from the print medium list 230.

The label management server 22 creates an extracted list in which the tape extracted in A45 (A46) is displayed on a priority basis, and displays a tape setting screen including the extracted list (A47). Specifically, the label management server 22 creates an extracted list LT2 in which “tape model number 3”, “tape model number 4”, “tape model number 5”, and “tape model number 6” extracted in A45 is displayed on a priority basis, and causes the terminal 12A to display a tape setting screen D8 including the created extracted list LT2 as illustrated in FIG. 9B. The extracted list LT1 is an example of a “second list”.

In the present embodiment, a tape having no item matching the set medium information 143 is excluded from the extracted list LT2. Therefore, the number of tapes included in the extracted list LT2 is smaller than that in the print medium list 230 illustrated in FIG. 8. Therefore, the tape setting screen D8 in FIG. 9B has a smaller number of tape options than a case where all the tapes of the print medium list 230 are displayed, which allows the poster to easily select the tape.

Moreover, in the extracted list LT2, the tape of “tape model number 4”, which matches all the items of the set medium information 143 is arranged above the tapes of “tape model number 3”, “tape model number 5”, and “tape model number 6”, which match some items of the set medium information 143, and is displayed at the head of the tape setting screen D8. This increases the possibility that the poster selects a tape matching the posted label data.

Further, if there are a plurality of tapes matching some items of the set medium information 143, the tapes are arranged in the extracted list LT2 in descending order of the number of matching items. Therefore, on the tape setting screen D8, a tape having a larger number of items matching the set medium information 143 is displayed closer to the head. This reduces the trouble for the poster to select a tape matching the label data to be posted, even if a tape matching some the items of the set medium information 143 is included in the extracted list LT2 and the selection of the tape is wide.

Returning to FIG. 7, the label management server 22 accepts the selection of the tape when one option is selected from the plurality of options displayed on the tape setting screen D7 or the tape setting screen D8 illustrated in FIGS. 9A and 9B (A51). That is, the poster can select a tape matching the posted label data from the tapes included in the print medium list 230. A51 is an example of “selection processing”.

When the registration button SW71 on the tape setting screen D7 or the registration button SW81 on the tape setting screen D8 illustrated in FIGS. 9A and 9B is operated, the label management server 22 accepts a registration instruction to register the posted label file in the label DB 26 (A52). The label management server 22 registers the posted label data in the label DB 26 (A53). The processing of A52 is an example of “upload acceptance processing”. The process of A53 is an example of “registration processing”.

Specifically, the label management server 22 creates a new label ID. The label management server 22 creates a record in which the label ID, the user ID of the poster, the label file acquired in A42, the tape information indicating the tape selected on the tape setting screen D7 or the tape setting screen D8, and the post date and time are associated with each other, and registers the record in the label DB 26. The tape information may include, for example, a tape width, a tape color, an ink color and a tape type. The tape information may further include a tape model number. The tape information may include only the tape model number. The tape information is an example of “second medium information”.

When the registration of the label file is complete, the label management server 22 notifies the terminal 12A (A54). The terminal 12A displays registration complete (A55).

### (Procedure of Download and Printing)

A procedure for downloading and printing label data will be described with reference to FIG. 10. Here, a case where the printing person downloads the label data from the label management server 22 to the own terminal 12B and causes the label printer 11B to print the label data will be described as an example.

In the client application 13B installed in the terminal 12B, the download button SW35 of the menu screen D3 illustrated in FIG. 4 is associated with a URL of a download screen provided by the label management server 22. The client application 13B accepts a download screen display instruction in response to an operation on the download button SW35 (B01). For example, the client application 13B accesses the URL of the download screen using its own browser function, and causes the terminal 12B to display the download screen provided from the label management server 22 (B02 and B03). If the client application 13B does not have a browser function, the client application 13B passes the URL to another program such as a browser. The other program causes the terminal 12B to display the download screen based on the URL.

When a download execution button (not illustrated) is operated in a state where the label data to be downloaded, that is, the label data as the transmission target is selected on the download screen, the label management server 22 accepts the download instruction (B11). The processing of B11 is an example of “download acceptance processing”. The download instruction is an example of a “transmission instruction”. The label ID of the selected label data is associated with the download instruction. The label management server 22 reads the label data corresponding to the label ID associated with the download instruction from the label DB 26 (B12), and transmits the label data to the terminal 12B that is the transmission source of the download instruction (B13). The processing of B13 is an example of “transmission processing”. Upon receiving the label data, the terminal 12B stores the label data in the memory 122 (B15).

For example, when printing the downloaded label data, the printing person causes the terminal 12B to display the edit screen D1 (C01). The printing person selects the downloaded label data on the edit screen D1 (C02). The printing person can edit the downloaded label data by operating the edit screen D1. When the print button SW11 is operated, the processing of C11 to C14 in FIG. 6 is executed, and the downloaded label data is printed.

When transmitting the label data to the terminal 12B, the label management server 22 also transmits the tape information associated with the label data in the label DB 26 to the terminal 12B. When displaying the label data downloaded on the edit screen D1, the client application 13B may automatically reflect the content of the tape information to the items of the setting area SA12. This increases the possibility that printing is performed with the quality intended by the poster.

As described above, when the terminal 12A acquires the body medium information 10A from the label printer 11A in advance, saves the label file 14A associated with the label data and uploads, that is, posts the label file 14A to the server, the label management server 22 acquires the body medium information 10 associated with the label data in the label file 14A by the server program 228 according to the first embodiment. The server extracts, from the print medium list 230, a tape fitting the acquired body medium information 10, and accepts selection of a tape from the extracted list LT1 in which the extracted tape is displayed on a priority basis. This allows the poster to easily select the tape suitable for the label data as the posting target when setting the tape at the time of posting, thereby reducing the trouble for selecting the tape.

### Second Embodiment

Next, a second embodiment of the technique disclosed in the present specification will be described. In the technique of the second embodiment, the terminal 12 extracts, from the print medium list 230, a tape fitting the body medium information, and accepts selection of a tape from the extracted list LT1 in which the extracted tape is displayed on a priority basis. This is different from the first embodiment in which the label management server 22 acquires the body medium information, extracts the tape fitting the body medium information from the print medium list 230, and accepts the selection of the tape from the extracted list LT1. Hereinafter, differences from the first embodiment will be described, and points common to the first embodiment will be denoted by the same reference signs as the first embodiment, and description thereof will be omitted as appropriate.

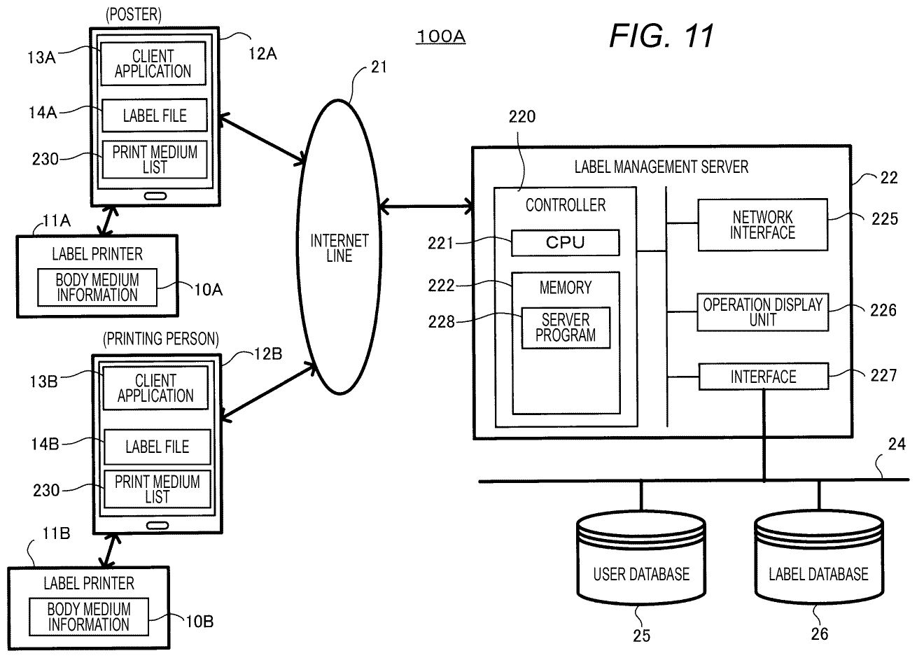

As illustrated in FIG. 11, in a label data sharing system 100A (hereinafter, referred to as a “system 100A”) according to the second embodiment, the print medium list 230 is held in the client applications 13A and 13B installed in the terminals 12A and 12B, and is not stored in the label management server 22. The print medium list 230 included in the terminals 12A and 12B is an example of a “first list”.

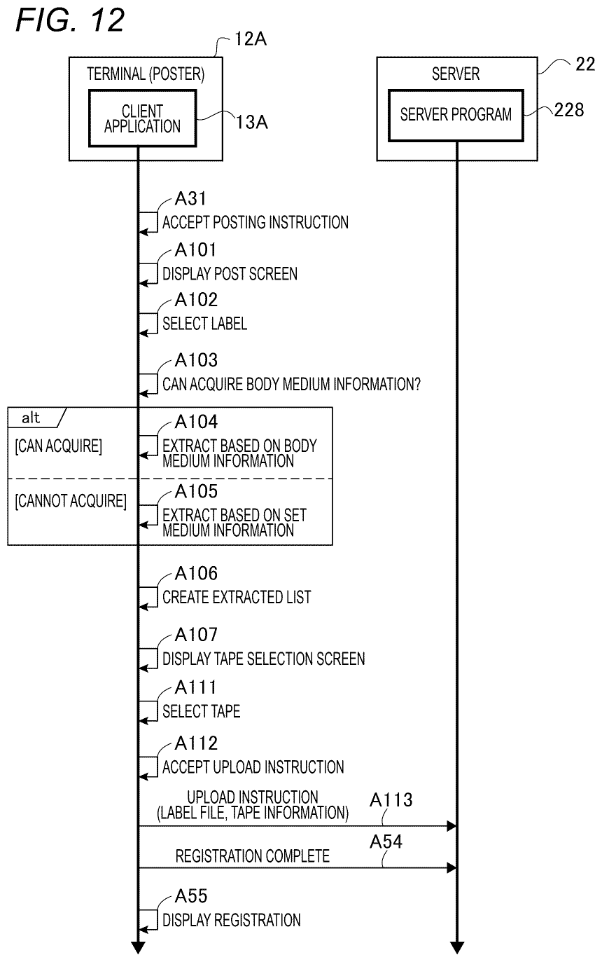

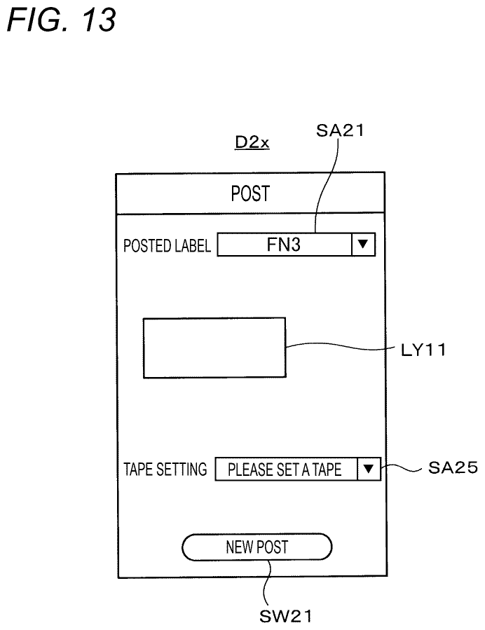

The posting procedure will be described with reference to FIG. 12. Here, a case where the poster posts the label file 14A from the terminal 12A to the label management server 22 will be described as an example. The client application 13A installed in the terminal 12A of the poster has a function of displaying, for example, a post screen D2x illustrated in FIG. 13 (A101). That is, since the post screen D2x is provided by the client application 13A, the client application 13A does not access the label management server 22 at the stage of displaying the post screen D2x. The post screen D2x of the present embodiment includes a tape setting field SA25 for setting a tape. This is different from the post screen D2 illustrated in FIG. 4, which does not include the tape setting field SA25.

When the client application 13A accepts the selection of the label file 14A as the posting target using the operation display unit 126 of the terminal 12A (A102), the client application 13A determines whether the body medium information 10A can be acquired from the selected label file 14A (A103). The processing of A102 is an example of “label data selection processing”.

In a case where the selected label file 14A includes the body medium information 10A and the body medium information 10A can be acquired (alt: can acquire), the client application 13A extracts, from the print medium list 230, a tape fitting the body medium information 10A (A104). The processing of A104 is an example of “extraction processing”. On the other hand, in a case where the selected label file 14A does not include the body medium information 10A and the body medium information 10A cannot be acquired (alt: cannot acquire), the client application 13A extracts, from the print medium list 230, a tape fitting the set medium information 143 included in the label file 14A (A105).

The client application 13A generates an extracted list LT1 in which the tape extracted in A104 (A106) is displayed on a priority basis. Alternatively, the client application 13A creates the extracted list LT2 based on the tape extracted in A105 (A106). A103 to A106 are the same as A43 to A46 of FIG. 7. The extracted lists LT1 and LT2 are examples of a “second list”.

When the tape setting field SA25 is operated, the client application 13A causes the operation display unit 126 to display the extracted list LT1 or the extracted list LT2 (A107). The client application 13A uses the operation display unit 126 to select one tape from the plurality of tapes displayed in the extracted list LT1 or the extracted list LT2 (A111). The processing of A111 is an example of “print medium selection processing”.

When the new post button SW21 is operated, the client application 13A transmits an upload instruction to the label management server 22 (A113). The processing of A133 is an example of “upload processing”. In the upload instruction, the label file 14A selected as the posting target and the tape information indicating the tape selected from the extracted list LT1 or the extracted list LT2 are associated with each other. The tape information is an example of “second medium information”.

The label management server 22 creates a label ID, creates a record in which the label file 14A, the tape information, the user ID of the poster, and the post date and time are associated with the label ID, and registers the record in the label DB 26 (A114). The user ID of the poster may be transmitted by the client application 13A in association with the upload instruction, or may be a user ID used by the label management server 22 for user authentication of the poster. When the registration of the label data is complete, the label management server 22 notifies the terminal 12A (A54). The terminal 12A displays registration complete (A55).

As described above, the client application 13A of the second embodiment acquires the body medium information 10A from the label printer 11A in advance and saves the label file 14A associated with the label data. The client application 13A extracts, from the print medium list 230, a tape fitting the body medium information 10A associated with the label data in the label file 14A selected as the posting target. The client application 13A accepts selection of a tape from the extracted list LT1 in which the extracted tape is displayed on a priority basis. The client application 13A uploads the label file 14A selected as the posting target and the tape information on the tape selected from the extracted list LT1 to the label management server 22 in association with each other. This allows the poster to easily select the tape suitable for the label data as the posting target when setting the tape at the time of posting, thereby reducing the trouble for selecting the tape.

The embodiments disclosed in the present specification are merely an example, and does not limit the present invention. Therefore, various improvements and modifications can be naturally made to the technique disclosed in the present specification without departing from the gist of the present invention. The number of label printers 11 connected to the terminal 12 is not limited to the illustrated example, and may be two or more.

The items of each print medium are not limited to the above embodiments. For example, the tape type may not be included. If the label printer 11 can grasp the tape model number, the item of each print medium may include the tape model number.

The tape extracted from the print medium list 230 based on the body medium information or the set medium information may be prioritized by a method other than displaying the tape at the top. For example, the tape fitting the body medium information or the set medium information may be prioritized by changing the display method, such as changing the font or color of the tapes not fitting the body medium information or the set medium information.

The tape extracted from the print medium list 230 may be a tape including an item similar to or compatible with the items of the body medium information or the set medium information. For example, a tape having a tape width within ±10% with respect to the tape width included in the body medium information or the set medium information may be extracted. This can widen the range for the user to select the tape within a range without hindering the printing of the label printer.

The client application 13 may save the body medium information separately from the label data. For example, the client application 13 may include a folder dedicated to body medium information and a folder dedicated to label data. However, if the body medium information can be managed in one label file 14 in association with the label data, the processing of associating the body medium information with the label data is simplified.

The client application 13 may acquire the body medium information 10 from the label printer 11 only when the label data is edited or printed. However, by acquiring at both timings, the client application 13 can associate the latest body medium information 10 with the label data, and the user can easily select a tape fitting the label printer 11.

The label management server 22 may not have the function of transmitting the label data to the terminal 12. However, if the label management server 22 has the function of transmitting the label data to the terminal 12, another user can use the label data uploaded to the label management server 22.

When saving the body medium information in association with the label data, if another body medium information is already associated with the label data, the client application 13 may separately save the label file. However, the memory load of the terminal 12A can be reduced by overwriting the label data.

In the process of A44, only a tape matching all the items of the body medium information may be extracted from the print medium list 230. By extracting a tape completely matching the body medium information from the print medium list 230, the possibility that the optimal tape is extracted increases, and the possibility that the user can select the appropriate print medium increases. However, by extracting, from the print medium list 230, a tape matching at least some items among the plurality of items included in the body medium information, the possibility that more tape options are extracted increases, and the possibility that an appropriate tape can be selected increases.

The extracted list LT1 or the extracted list LT2 may not be created such that a print medium having more items matching the body medium information or the set medium information among the tapes extracted in A44 or A45 is prioritized. However, a tape having a larger number of matching items is estimated to have a higher possibility to be selected. Therefore, the trouble for selecting the print medium is further reduced by displaying a tape having a large number of matching items prior to a tape having a small number of matching items.

The extracted list LT1 or the extracted list LT2 may not include only the extracted tape. In this case, the extracted tape and the unextracted tape may be displayed in a distinguishable manner, or the extracted tape may be displayed above the unextracted tape. However, by configuring the extracted lists LT1 and LT2 with only the extracted tape, the number of tape options is reduced, and the poster can easily select the tape.

The processing of A45 may be omitted if the body medium information is not associated with the label data and the label management server 22 cannot acquire the body medium information. In this case, for example, a tape may be selected from the print medium list 230. However, even if the label data is not associated with the body medium information, by extracting the tape based on the set medium information, the trouble for selecting the tape at the time of posting the label data is reduced.

The label management server 22 may include a first server having a web server function and a second server having a function different from the web server function. For example, the first server may accept the list request by a web server function and transmit the label data list. On the other hand, the second server may extract the body medium information corresponding to the user ID and extract the label data from the label database. The first server and the second server may cooperate to accept the list request, extract the body medium information and the label data, and transmit the label data list.

The display of each screen is not limited to the above embodiments. For example, the tape setting screen D7 may display the body medium information.

In any sequence diagram disclosed in the embodiments, an execution order of any plurality of processes can be freely changed or can be executed in parallel within a range in which no contradiction occurs in a processing content.

The processes disclosed in the embodiments may be executed by hardware such as a single CPU, a plurality of CPUs, and an ASIC, or a combination thereof. In addition, the processes disclosed in the embodiments can be implemented in various modes such as a recording medium in which a program for executing the processes is recorded, or a method.

What is claimed is:

1. A non-transitory computer readable storage medium storing a program, the program being configured to be executed by a server configured to connect to an information processing device, the server including a first list that is a list of print media configured to be set,
wherein the program comprising instructions that, when executed by the server, cause a computer of the server to execute:
upload acceptance processing of accepting an upload of label data from the information processing device; and
acquisition processing of acquiring first medium information associated with the label data accepted in the upload acceptance processing,
the information processing device is configured to acquire, from a label printer connected to the information processing device, the first medium information indicating a print medium mounted on the label printer, and to store the acquired first medium information in association with the label data,
the instructions further cause the computer of the server to execute:
first extraction processing of extracting, from the first list, a print medium matching the first medium information acquired in the acquisition processing;
selection processing of accepting selection of a print medium from a second list, the second list being a list of print media in which the print medium extracted in the first extraction processing is displayed on a priority basis; and
registration processing of registering the label data accepted in the upload acceptance processing in association with second medium information indicating the print medium selected in the selection processing.

2. The non-transitory computer readable storage medium according to claim 1,
wherein the first medium information includes one or a plurality of items, and
in the first extraction processing, a print medium, is extracted from the first list, the print medium matching all items of the first medium information acquired in the acquisition processing.

3. The non-transitory computer readable storage medium according to claim 1,
wherein the first medium information includes a plurality of items, and
in the first extraction processing, a print medium is extracted from the first list, the print medium matching at least one item of the first medium information acquired in the acquisition processing.

4. The non-transitory computer readable storage medium according to claim 3,
wherein in the selection processing, a selection of the print medium is accepted from the second list in which a print medium having a larger number of matching items among print media extracted in the first extraction processing is displayed on the priority basis.

5. The non-transitory computer readable storage medium according to claim 1,
wherein in the selection processing, a selection of the print medium is accepted from the second list including the print medium extracted in the first extraction processing.

6. The non-transitory computer readable storage medium according to claim 1,
wherein the instructions causes the computer of the server to execute:
in a case where the first medium information is associated with the label data accepted in the upload acceptance processing and the first medium information is acquired in the acquisition processing, the first extraction processing of extracting a print medium matching the acquired first medium information from the first list; and
in a case where the first medium information is not associated with the accepted label data and the first medium information is not acquired, second extraction processing of extracting a print medium from the first list, based on information set in the label data accepted in the upload acceptance processing, and
in the selection processing, a selection of the print medium is accepted from the second list in which the print medium extracted in the first extraction processing or the second extraction processing is displayed on the priority basis.

7. The non-transitory computer readable storage medium according to claim 1, wherein
in the acquisition processing, the first medium information included in the label data accepted in the upload acceptance processing is acquired, and the information processing device saves the first medium information to be included in the label data to store the first medium information in association with the label data, the first medium information being acquired from the label printer.

8. The non-transitory computer readable storage medium according to claim 1,
wherein the instructions causes the computer of the server to execute:
download acceptance processing of accepting, from an other information processing device different from the information processing device, a transmission instruction to transmit the label data registered in the registration processing; and
transmission processing of transmitting, to the other information processing device, the label data designated as a transmission target by the transmission instruction accepted in the download acceptance processing.

9. A non-transitory computer readable storage medium storing a program, the program being configured to be executed by an information processing device configured to be connected to a label printer,
wherein the program comprising instructions that, when executed by the server, causes a computer of the information processing device to execute:
acquisition processing of acquiring, from the label printer, first medium information indicating a print medium mounted on the label printer;
saving processing of saving the first medium information acquired in the acquisition processing in association with label data;
label data selection processing of accepting selection of label data, as a posting, via a user interface of the information processing device;
extraction processing of extracting print medium matching the first medium information saved in association with the label data selected in the label data selection processing from a first list, the first list being a list of print media configured to be set;
print medium selection processing of accepting selection of print medium from a second list, via the user interface of the information processing device, the second list being a list of print media in which the print medium extracted in the extraction processing is displayed on the priority basis; and
upload processing of reading the label data selected in the label data selection and of uploading, to the server, the read label data in association with second medium information indicating the print medium selected in the print medium selection processing.

10. A server for connecting to an information processing device via a network,
wherein the server includes a first list that is a list of print media configured to be set,
the server is configured to execute:
upload acceptance processing of accepting an upload of label data from the information processing device; and
acquisition processing of acquiring first medium information associated with the label data accepted in the upload acceptance processing,
the information processing device is configured to acquire, from a label printer connected to the information processing device, the first medium information indicating a print medium mounted on the label printer, and to store the acquired first medium information in association with the label data,
the server is further configured to execute:
first extraction processing of extracting, from the first list, a print medium matching the first medium information acquired in the acquisition processing;
selection processing of accepting selection of a print medium from a second list, the second list being a list of print media in which the print medium extracted in the first extraction processing is displayed on a priority basis; and
registration processing of registering the label data accepted in the upload acceptance processing in association with second medium information indicating the print medium selected in the selection processing.

11. A label data sharing system comprising:
an information processing device;
a label printer; and
a server,
wherein the server includes a first list that is a list of print media configured to be set,
the information processing device is configured to execute:
acquisition processing of acquiring, from the label printer, first medium information indicating a print medium mounted on the label printer; and
saving processing of saving the first medium information acquired in the acquisition processing in association with label data,
the server is configured to execute:
upload acceptance processing of accepting an upload of the label data from the information processing device;
acquisition processing of acquiring first medium information associated with the label data accepted in the upload acceptance processing;
first extraction processing of extracting, from the first list, a print medium matching the first medium information acquired in the acquisition processing;
selection processing of accepting selection of a print medium from a second list that is a list of print media in which the print medium extracted in the first extraction is displayed on a priority basis; and
registration processing of registering the label data accepted in the upload acceptance processing in association with second medium information indicating the print medium selected in the selection processing.
